(19) United States
(12) Patent Application Publication
(10) Pub. No.: US 2013/0196836 A1
(43) Pub. Date: Aug. 1, 2013

(54) CONDUCTIVE ROLLER, IMAGE-FORMING APPARATUS, AND PROCESS CARTRIDGE

(71) Applicant: Nobuyuki ICHIZAWA, Kanagawa (JP)

(72) Inventor: Nobuyuki ICHIZAWA, Kanagawa (JP)

(73) Assignee: FUJI XEROX CO., LTD., Tokyo (JP)

(21) Appl. No.: 13/559,089

(22) Filed: Jul. 26, 2012

(30) Foreign Application Priority Data
Jan. 26, 2012 (JP) 2012-014512

(51) Int. Cl. B05C 1/08; G03G 21/18

(52) U.S. Cl. 492/18; 399/111

(57) ABSTRACT

A conductive roller includes a conductive support, a conductive elastic layer disposed on the conductive support, and a conductive resin layer disposed on the conductive elastic layer and containing a resin and a conductor. The conductive resin layer includes a first region forming an outermost surface thereof and a second region between the first region and the conductive elastic layer. The second region adjoins the conductive elastic layer and has a lower surface resistivity than the first region.

### CROSS-REFERENCE TO RELATED APPLICATIONS

This application is based on and claims priority under 35 USC 119 from Japanese Patent Application No. 2012-014512 filed Jan. 26, 2012.

### BACKGROUND

(i) Technical Field

The present invention relates to conductive rollers, image-forming apparatuses, and process cartridges.

(ii) Related Art

Electrophotographic systems such as electrophotographic image-forming apparatuses include a large number of cylindrical members. Examples of such cylindrical members include image carriers, charging rollers (charging members), developing rollers (developing devices), transfer belts, transfer rollers (transfer devices), and fixing rollers (fixing devices).

### SUMMARY

According to an aspect of the invention, there is provided a conductive roller including a conductive support, a conductive elastic layer disposed on the conductive support, and a conductive resin layer disposed on the conductive elastic layer and containing a resin and a conductor. The conductive resin layer includes a first region forming an outermost surface thereof and a second region between the first region and the conductive elastic layer. The second region adjoins the conductive elastic layer and has a lower surface resistivity than the first region.

### BRIEF DESCRIPTION OF THE DRAWINGS

Exemplary embodiments of the present invention will be described in detail based on the following figures, wherein:

FIG. 1 is a schematic perspective view of a conductive roller according to an exemplary embodiment;

FIG. 2 is a schematic sectional view of the conductive roller according to the exemplary embodiment;

FIGS. 3A and 3B are a schematic plan view and a schematic sectional view, respectively, of an example of a circular probe for surface resistivity measurement;

FIG. 4 is a sectional view of an example of a coating apparatus for manufacturing a conductive resin layer of the conductive roller according to the exemplary embodiment;

FIGS. 5A to 5E illustrate an example of a process of manufacturing the conductive resin layer of the conductive roller according to the exemplary embodiment;

FIG. 6 is a schematic view of an image-forming apparatus according to the exemplary embodiment; and

FIG. 7 is a schematic view illustrating a volume resistance measurement procedure in the Examples.

### DETAILED DESCRIPTION

Exemplary embodiments of the present invention will now be described with reference to the drawings.

### Conductive Roller

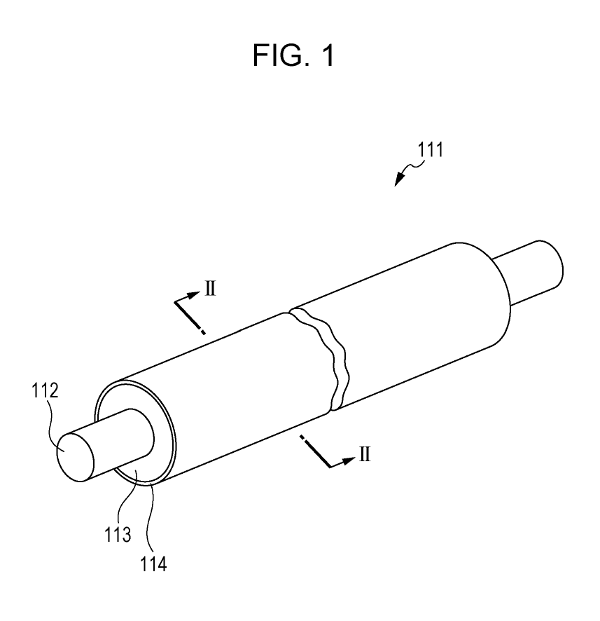

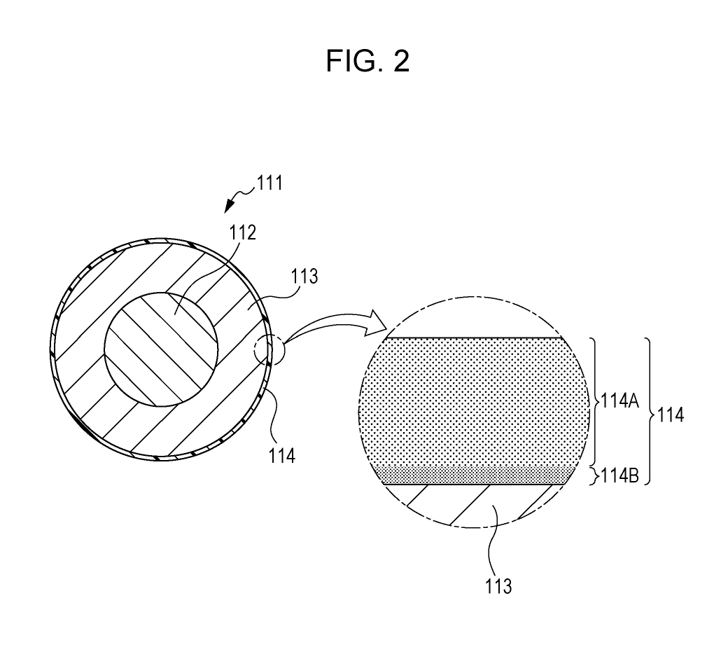

FIG. 1 is a schematic perspective view of a conductive roller according to an exemplary embodiment. FIG. 2 is a schematic sectional view of the conductive roller according to this exemplary embodiment, taken along line II-II of FIG. 1.

As shown in FIGS. 1 and 2, a conductive roller 111 according to this exemplary embodiment includes, for example, a hollow or solid cylindrical conductive support (shaft) 112, a conductive elastic layer 113 disposed on the outer surface of the conductive support 112, and a conductive resin layer 114 disposed on the outer surface of the conductive elastic layer 113.

The conductive resin layer 114 includes a first region 114A forming the outermost surface thereof and a second region 114B adjoining the conductive elastic layer 113 and having a lower surface resistivity than the first region 114A.

The conductive roller 111, thus constructed, according to this exemplary embodiment may maintain its low volume resistance after repeated use.

While the mechanism is not fully understood, it is believed to be as follows.

One known conductive roller includes a foamed elastic roller member and an unfoamed rubber or resin layer disposed on the surface (outer surface) of the foamed elastic roller member as a surface layer. The foamed elastic roller member includes a conductive support and a conductive elastic layer disposed thereon. The known conductive roller tends to accumulate a charge between the conductive elastic layer and the surface layer because of poor charge transfer therebetween. This might increase the volume resistance of the conductive roller 111 after repeated use.

In this exemplary embodiment, the conductive resin layer 114 includes the first region 114A forming the outermost surface thereof and the second region 114B adjoining the conductive elastic layer 113 and having a lower surface resistivity than the first region 114A. The conductive resin layer 114 may allow smooth charge transfer between the conductive elastic layer 113 and the conductive resin layer 114, thus accumulating little charge therebetween. As a result, the conductive roller 111 may maintain its low volume resistance after repeated use.

The illustrated structure is not intended to be limiting. For example, the conductive roller 111 according to this exemplary embodiment may include an intermediate layer between the conductive elastic layer 113 and the conductive support 112.

The conductive roller 111 according to this exemplary embodiment is applicable to, for example, conductive rollers for image-forming apparatuses, including transfer rollers, charging rollers, and cleaning rollers (e.g., cleaning rollers for charging rollers).

For example, if the conductive roller 111 according to this exemplary embodiment is applied to a transfer roller, the transfer roller may maintain its low volume resistance after repeated use. The transfer roller may therefore cause few image defects after repeated use.

The components of the conductive roller 111 according to this exemplary embodiment will now be described in detail.

### Conductive Support

The conductive support 112 functions both as an electrode and as a support for the conductive roller 111.

The conductive support 112 is made of, for example, a metal such as iron (e.g., free-cutting steel), copper, brass, stainless steel, aluminum, or nickel.

The conductive support 112 may also be, for example, a member (e.g., a resin or ceramic member) having the outer surface thereof plated or a member (e.g., a resin or ceramic member) having a conductor dispersed therein.

The conductive support 112 may be either a hollow member (tubular member) or a solid member.

### Conductive Elastic Layer

The conductive elastic layer 113 contains, for example, a rubber (elastomer) and optionally a conductor and other additives. The conductive elastic layer 113 may be either a foamed conductive elastic layer or an unfoamed conductive elastic layer.

The rubber (elastomer) is, for example, an elastomer having at least a double bond in the chemical structure thereof.

Examples of rubbers include isoprene rubber, chloroprene rubber, epichlorohydrin rubber, butyl rubber, polyurethane, silicone rubber, fluoroelastomer, styrene-butadiene rubber, butadiene rubber, nitrile rubber, ethylene-propylene rubber, epichlorohydrin-ethylene oxide copolymer rubber, epichlorohydrin-ethylene oxide-allyl glycidyl ether copolymer rubber, ethylene-propylene-diene monomer terpolymer rubber (EPDM), acrylonitrile-butadiene copolymer rubber (NBR), natural rubber, and mixtures thereof.

Particularly preferred are polyurethane, EPDM, epichlorohydrin-ethylene oxide copolymer rubber, epichlorohydrin-ethylene oxide-allyl glycidyl ether copolymer rubber, NBR, and mixtures thereof.

The conductor is optionally used, particularly if the rubber has low or no conductivity. The conductor is, for example, an electron conductor or an ionic conductor.

Examples of electron conductors include carbon blacks such as Ketjenblack and acetylene black; pyrolytic carbon; graphite; powdered conductive metals and alloys such as aluminum, copper, nickel, and stainless steel; powdered conductive metal oxides such as tin oxide, indium oxide, titanium oxide, tin oxide-antimony oxide solid solution, and tin oxide-indium oxide solid solution; and powdered insulating materials having the surfaces thereof treated to impart conductivity.

Examples of carbon blacks include Special Black 350, Special Black 100, Special Black 250, Special Black 5, Special Black 4, Special Black 4A, Special Black 550, Special Black 6, Color Black FW200, Color Black FW2, and Color Black FW2V available from Degussa AG and MONARCH 1000, MONARCH 1300, MONARCH 1400, MOGUL-L, and REGAL 400R available from Cabot Corporation.

Such electron conductors may be used alone or in combination.

The content of the electron conductor may be, for example, 1 to 30 parts by mass, preferably 15 to 25 parts by mass, per 100 parts by mass of the rubber.

Examples of ionic conductors include quaternary ammonium salts (e.g., perchlorates, chlorates, hydrofluoroborates, sulfates, ethosulfates, and benzyl halides (e.g., benzyl bromides and benzyl chlorides) of lauryl trimethyl ammonium, stearyl trimethyl ammonium, octadodecyl trimethyl ammonium, dodecyl trimethyl ammonium, hexadecyl trimethyl ammonium, and modified fatty acid dimethyl ethyl ammonium)), salts of aliphatic sulfonic acids, salts of sulfuric acid esters of fatty alcohols, ethylene oxide adducts of salts of sulfuric acid esters of fatty alcohols, salts of phosphoric acid esters of fatty alcohols, ethylene oxide adducts of salts of phosphoric acid esters of fatty alcohols, betaines, ethylene oxide adducts of fatty alcohols, fatty acid esters of polyethylene glycol, and fatty acid esters of polyalcohols.

Such ionic conductors may be used alone or in combination.

The content of the ionic conductor may be, for example, 0.1 to 5.0 parts by mass, preferably 0.5 to 3.0 parts by mass, per 100 parts by mass of the rubber.

Examples of other additives include materials that are commonly added to elastic layers, such as foaming agents, foaming aids, softeners, plasticizers, curing agents, vulcanizers, vulcanization accelerators, antioxidants, surfactants, coupling agents, and fillers (e.g., silica and calcium carbonate).

The thickness of the conductive elastic layer 113 may be, for example, 5 to 20 mm, preferably 5 to 15 mm.

The common logarithm of the volume resistance of the conductive elastic layer 113 measured at a temperature of 22° C., a humidity of 55% RH, and an applied voltage of 1,000 V may be 6.0 to 8.0 (log Ω), preferably 6.3 to 7.8 (log Ω), more preferably 6.6 to 7.8 (log Ω).

The volume resistance of the conductive elastic layer 113 is adjusted depending on, for example, the type and amount of conductor added.

### Conductive Resin Layer

The conductive resin layer 114 contains a resin, a conductor, and optionally other additives. The conductive resin layer 114 includes the first region 114A forming the outermost surface thereof and the second region 114B adjoining the conductive elastic layer 113 and having a lower surface resistivity than the first region 114A.

The conductive resin layer 114 is, for example, tensioned to come into close contact with the conductive elastic layer 113.

The conductive resin layer 114 includes the first region 114A and the second region 114B as layers stacked in the radial direction of the conductive roller 111.

The first region 114A and the second region 114B are continuous in the resin matrix, i.e., have no interface therebetween. The first region 114A and the second region 114B contain different amounts of conductor. Specifically, the second region 114B contains a larger amount of conductor than the first region 114A.

The conductive resin layer 114 may include the first region 114A and the second region 114B with an intermediate region therebetween as layers stacked in the radial direction of the conductive roller 111. The conductive resin layer 114, however, may include only the first region 114A and the second region 114B.

The thickness of the conductive resin layer 114 may be, for example, 50 to 150 μm, preferably 70 to 100 μm.

The first region 114A may be thicker than the second region 114B. The second region 114B forms a surface region extending from the surface of the conductive resin layer 114 adjoining the conductive elastic layer 113. The surface region is a region extending from the surface of the conductive resin layer 114 adjoining the conductive elastic layer 113 to a depth of, for example, 1 μm.

The difference between the common logarithms (log Ω/sq) of the surface resistivities of the first region 114A and the second region 114B (common logarithm of surface resistivity of first region 114A—common logarithm of surface resistivity of second region 114B) is preferably 1 to 3 or about 1 to about 3, more preferably 1.1 to 2.8 or about 1.1 to about 2.8. This may allow the conductive roller 111 to maintain its low volume resistance more effectively after repeated use.

The surface resistivity of the first region 114A and the second region 114B is measured by the following procedure.

The conductive resin layer 114 of the conductive roller 111 is first cut open into a sheet. The sheet is cut in the center thereof to form a 4×4 cm measurement sample.

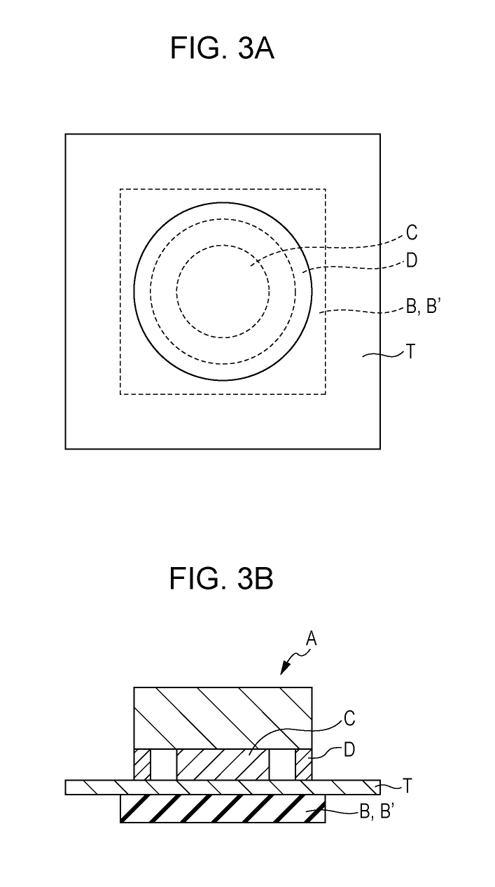

The surface resistivity is measured using a circular probe (e.g., UR Probe for HIRESTA IP available from Mitsubishi Petrochemical Co., Ltd.) in accordance with JIS K 6911 (Japanese Industrial Standards). The procedure for measuring the surface resistivity will now be described with reference to FIGS. 3A and 3B.

FIGS. 3A and 3B are a schematic plan view and a schematic sectional view, respectively, of an example of a circular probe. The circular probe illustrated in FIGS. 3A and 3B includes a first voltage-applying electrode A and an insulating plate B. The first voltage-applying electrode A includes a cylindrical electrode portion C and a ring electrode portion D having an inner diameter larger than the outer diameter of the cylindrical electrode portion C and surrounding the cylindrical electrode portion C at a predetermined spacing.

The surface resistivity of the first region 114A (the surface resistivity of the outermost surface of the conductive resin layer 114) is determined as follows. The measurement sample (indicated at T in FIGS. 3A and 3B) is held between the electrode portions C and D of the first voltage-applying electrode A and the insulating plate B, with the first region 114A facing upward. A voltage V (V) is then applied across the electrode portions C and D of the first voltage-applying electrode A to measure the current I (A) that flows thereacross. The surface resistivity ρs (Ω/sq) is calculated by the following equation:

ρs=π×(D+d)/(D−d)×(V/I)

where d (mm) is the outer diameter of the cylindrical electrode portion C, and D (mm) is the inner diameter of the ring electrode portion D.

To measure the surface resistivity of the second region 114B (the surface resistivity of the surface of the conductive resin layer 114 adjoining the conductive elastic layer 113), the measurement sample (indicated at T in FIGS. 3A and 3B) is held between the electrode portions C and D of the first voltage-applying electrode A and the insulating plate B, with the second region 114B facing upward.

In this exemplary embodiment, the surface resistivity of the conductive resin layer 114 is calculated from the current measured using a circular probe (UR Probe for HIRESTA IP available from Mitsubishi Petrochemical Co., Ltd., outer diameter of cylindrical electrode portion C: 16 mm, inner diameter of ring electrode portion D: 30 mm, outer diameter of ring electrode portion D: 40 mm) at 22° C. and 55% RH after a voltage of 1,000 V is applied for ten seconds.

The common logarithm of the surface resistivity of the first region 114A may be 9.0 to 13.0 (log Ω/sq), preferably 10.0 to 12.5 (log Ω/sq), more preferably 11.0 to 12.0 (log Ω/sq), to ensure high image quality.

The common logarithm of the surface resistivity of the second region 114B may be 6.0 to 11.0 (log Ω/sq), preferably 7.0 to 10.5 (log Ω/sq), more preferably 8.0 to 10.0 (log Ω/sq), to ensure high image quality.

The surface resistivities of the first region 114A and the second region 114B are adjusted depending on, for example, the type and amount of conductor added.

The common logarithm of the volume resistance of the conductive resin layer 114 measured at a temperature of 22° C., a humidity of 55% RH, and an applied voltage of 100 V may be 6.0 to 10.0 (log Ω), preferably 7.0 to 9.5 (log Ω), more preferably 8.0 to 9.0 (log Ω).

The volume resistance of the conductive resin layer 114 is adjusted depending on, for example, the type and amount of conductor added.

The volume resistance of the conductive resin layer 114 is measured using a circular probe (e.g., UR Probe for HIRESTA IP available from Mitsubishi Petrochemical Co., Ltd.) in accordance with JIS K 6911.

The procedure for measuring the volume resistance of the conductive resin layer 114 will now be described with reference to FIGS. 3A and 3B. The system and sample used for volume resistance measurement are the same as for surface resistivity measurement of the first region 114A and the second region 114B except that the insulating plate B, used for surface resistivity measurement, of the circular probe illustrated in FIGS. 3A and 3B is replaced by a second voltage-applying electrode B′.

The measurement sample (indicated at T in FIGS. 3A and 3B) is held between the electrode portions C and D of the first voltage-applying electrode A and the second voltage-applying electrode B′. A voltage V (V) is then applied across the cylindrical electrode portion C of the first voltage-applying electrode A and the second voltage-applying electrode B′ to measure the current I (A) that flows thereacross. The resistance R (Ω) of the measurement sample is calculated by the equation R=V/I.

In this exemplary embodiment, the volume resistance of the conductive resin layer 114 is calculated from the current measured using a circular probe (UR Probe for HIRESTA IP available from Mitsubishi Petrochemical Co., Ltd., outer diameter of cylindrical electrode portion C: 16 mm, inner diameter of ring electrode portion D: 30 mm, outer diameter of ring electrode portion D: 40 mm) at 22° C. and 55% RH after a voltage of 100 V is applied for ten seconds.

The constituents of the conductive resin layer 114 will now be described.

Examples of suitable resins include thermoplastic resins such as polycarbonate, polyvinylidene fluoride, polyalkylene phthalate, mixtures of polycarbonate and polyalkylene phthalates, and ethylene-tetrafluoroethylene copolymer; and thermosetting resins such as polyimide and polyimide-polyamide copolymer (i.e., polyamideimide).

Such resins may be used alone or in combination.

Examples of suitable conductors include electron conductors and ionic conductors. Examples of electron conductors and ionic conductors include those described for the conductive elastic layer 113.

Particularly preferred conductors include conductive particles such as carbon black, graphite, aluminum, nickel, copper, tin oxide, zinc oxide, titanium oxide, and potassium titanate and organic conductors such as polyaniline and polythiophene.

To ensure high strength and elastic modulus, the conductive resin layer 114 may be a conductive resin layer containing polyimide as the major component (i.e., having a polyimide content of more than 50% by mass) and having conductive particles, such as carbon black, dispersed therein as a conductor.

Examples of other additives include materials that are commonly added to resin layers, such as plasticizers, curing agents, softeners, antioxidants, and surfactants.

A method for manufacturing the conductive roller 111 according to this exemplary embodiment will now be described.

The method begins with providing a roller member including the hollow or solid cylindrical conductive support (shaft) 112 and the conductive elastic layer 113 disposed on the outer surface of the conductive support 112.

The conductive resin layer 114 may be provided on the outer surface of the conductive elastic layer 113 in any manner. For example, the conductive resin layer 114 may be provided on the outer surface of the conductive elastic layer 113 by providing a tubular member that forms the conductive resin layer 114 and inserting the roller member into the tubular member, thus obtaining the conductive roller 111 according to this exemplary embodiment.

The member that forms the conductive resin layer 114 may be manufactured in any manner. For example, a conductor may be transferred to one of the surface regions of a material layer containing a resin and a conductor from another material layer (hereinafter “transfer process”). Alternatively, a conductor may be concentrated in a material layer containing a resin and a conductor (hereinafter “concentration process”).

### Transfer Process

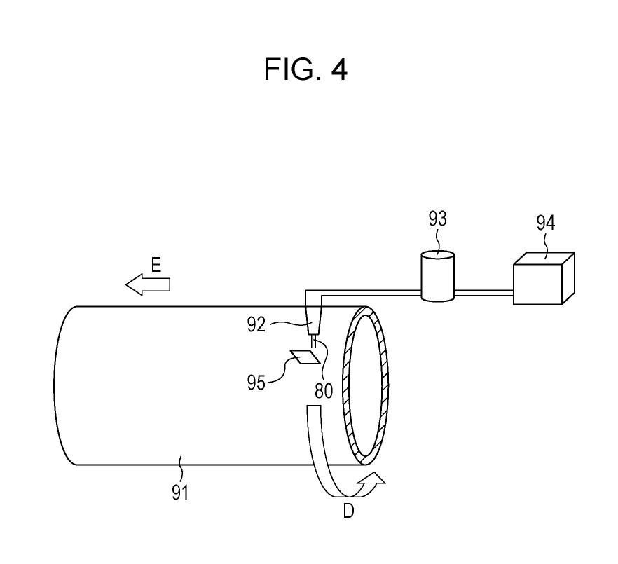

Referring now to FIG. 4, the transfer process is illustrated.

The process begins with preparing a coating solution 80 containing a resin, a conductor, and a solvent. The coating solution 80 has the amount of conductor depending on the required surface resistivity of the first region 114A dissolved or dispersed therein. The conductor may be dispersed by a known process, such as using a jet mill, roller mill, ball mill, vibrating ball mill, attritor, sand mill, colloid mill, or paint shaker.

The solvent is selected depending on the resin. The coating solution 80 may have a solid content of, for example, 10% to 40% by mass and a viscosity of, for example, 1 to 100 Pa·s.

A cylindrical mold 91 is provided that has an outer diameter corresponding to the inner diameter of the conductive resin layer 114 (the outer diameter of the conductive elastic layer 113). A release agent such as a silicone release agent is then applied at least to the outer surface of the cylindrical mold 91 and is baked to form a release agent layer. The release agent applied to the cylindrical mold 91 has the type and amount of conductor depending on the required surface resistivity of the second region 114B dissolved or dispersed therein. Thus, the conductor is contained in the release agent layer formed on the outer surface of the cylindrical mold 91.

The conductor used for the release agent may be the same as or different from the conductor used for the coating solution 80. The conductor used for the release agent may be in particle or powder form.

FIG. 4 illustrates an example of a coating apparatus used for the transfer process. The coating apparatus includes a nozzle 92 from which the coating solution 80 is ejected onto the outer surface of the cylindrical mold 91 at a position along the outer surface of the cylindrical mold 91. The nozzle 92 is connected through a pipe to a coating solution container 93 that is in turn connected through another pipe to a pressurizing device 94. A blade 95 is disposed below the nozzle 92 to level off the coating solution 80 deposited on the outer surface of the cylindrical mold 91.

The coating apparatus is used to apply the coating solution 80 to the cylindrical mold 91 having the release agent layer. Specifically, while the cylindrical mold 91 is rotated in the rotational direction of the cylindrical mold 91 (indicated by the arrow D), the coating solution 80 is ejected from the nozzle 92 onto the outer surface of the cylindrical mold 91 and is leveled off on the outer surface of the cylindrical mold 91 by the blade 95. As the nozzle 92 and the blade 95 are moved at a predetermined speed in the moving direction of the nozzle 92 and the blade 95 (indicated by the arrow E), the coating solution 80 is applied to a predetermined thickness on the outer surface of the cylindrical mold 91. The pressurizing device 94 is adjusted such that the coating solution 80 is ejected from the nozzle 92 at a predetermined rate. Thus, a coating of the coating solution 80 is formed on the outer surface of the cylindrical mold 91. The thickness of the resulting member that forms the conductive resin layer 114 is adjusted depending on the amount of coating solution 80 ejected, the moving speed of the nozzle 92 and the blade 95, and the solid content of the coating solution 80.

The coating of the coating solution 80 is then dried with heat. After cooling, the coating is released from the cylindrical mold 91 and is cut to the width corresponding to the width of the conductive elastic layer 113 to obtain a tubular member that forms the conductive resin layer 114.

If the resin used for the coating solution 80 is a polyimide precursor, a coating of the coating solution 80 is formed on the outer surface of the cylindrical mold 91, is dried at 80° C. to 170° C. to remove the solvent (drying step), and is heated to 200° C. to 350° C. to facilitate imide conversion (baking step), thus forming a polyimide film. After cooling, the polyimide film is released from the cylindrical mold 91 and is cut to the width corresponding to the width of the conductive elastic layer 113 to obtain a tubular member that forms the conductive resin layer 114.

The resulting member that forms the conductive resin layer 114 contains the conductor transferred from the release agent layer to the surface region adjoining the cylindrical mold 91. The surface region of the conductive resin layer 114 adjoining the cylindrical mold 91 contains a larger amount of conductor than the other region; that is, the conductor is localized in the surface region. The second region 114B thus has a lower surface resistivity than the first region 114A.

### Concentration Process

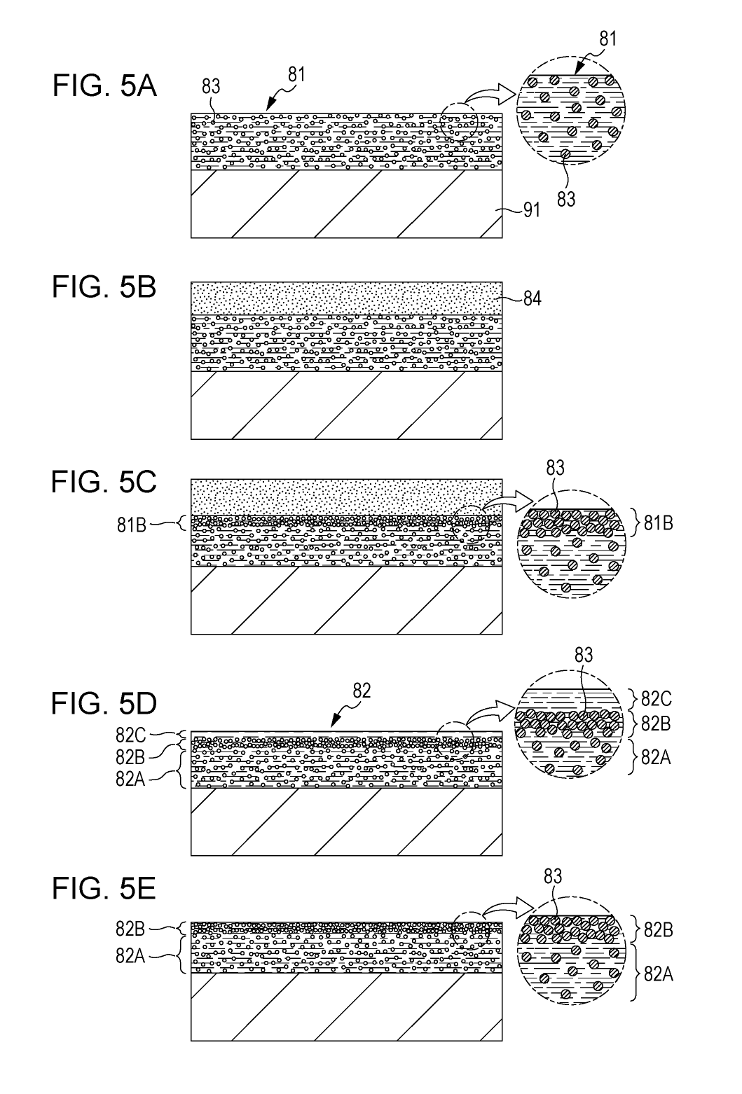

Referring now to FIGS. 5A to 5E, the concentration process is illustrated.

The process begins with preparing a coating solution containing a resin, a conductor 83, and a solvent. The coating solution has the amount of conductor 83 depending on the required surface resistivity of the first region 114A dissolved or dispersed therein. The conductor 83 used for the concentration process may be in particle or powder form.

This process uses a cylindrical mold 91 having an inner diameter corresponding to the outer diameter of the conductive resin layer 114 because the coating solution is applied to the inner surface of the cylindrical mold 91.

The coating solution is applied to the cylindrical mold 91 to form a coating 81 of the coating solution, as illustrated in FIG. 5A.

The coating solution may be applied to the cylindrical mold 91 in any manner. For example, the coating solution may be applied to the inner surface with a blade, or may be applied to a portion of the inner surface and be spread over the entire surface by centrifugation. Release treatment may be applied to at least the inner surface of the cylindrical mold 91.

The coating 81 on the cylindrical mold 91 is then dried. The coating 81 may be dried to a residual solvent content of 25% or less, preferably 20% or less, more preferably 15% or less. As the residual solvent content becomes higher, the conductor 83 is less localized (concentrated). As the residual solvent content becomes lower, the conductor 83 is more localized (concentrated). By controlling the residual solvent content, i.e., the dryness of the coating 81, the degree of localization (concentration) of the conductor 83 and the thickness of the region where the conductor 83 is localized in the conductive resin layer 114 (conductor-localized region 82B) can be controlled.

As used herein, the term “residual solvent content” refers to the proportion of the weight of the solvent remaining in the coating after drying to the weight of the solvent contained in the coating solution. The residual solvent content is calculated as follows.

For example, if the solid weight of the resin (the dry weight of the resin) and the weight of the conductor are known, the total weight of the coating before drying is accurately weighed, and the weight of the solvent contained in the coating is calculated. The total weight of the coating after drying is then accurately weighed. Assuming that the decrease is equivalent to the loss of the weight of the solvent, (weight of coating before drying−weight of coating after drying)/(weight of coating before drying−solid weight of resin−weight of conductor) is calculated, and the residual solvent content is determined.

Alternatively, the residual solvent content may be determined using a thermal extraction gas chromatograph mass spectrometer system. An example of the measurement procedure is illustrated below. The coating after drying is cut to obtain, for example, about 2 to about 3 mg of specimen. After weighing, the specimen is heated to 400° C. in a thermal extractor (PY2020D available from Frontier Laboratories Ltd.). The volatile component evaporated from the specimen is injected through an interface at 320° C. into a gas chromatograph mass spectrometer (GCMS-QP2010 available from Shimadzu Corporation) and is quantified. Specifically, 1/51 (split ratio=50:1) of the volatile component evaporated from the specimen is injected into a column having an inner diameter of 0.25 μm and a length of 30 m (UA-5 capillary column available from Frontier Laboratories Ltd.) using helium gas as a carrier gas at a linear velocity of 153.8 cm/sec (carrier gas flow rate at column temperature of 50° C.: 1.50 mL/min, pressure: 50 kPa). The column is maintained at 50° C. for 3 minutes, is heated to 400° C. at 8° C./min, and is maintained at that temperature for 10 minutes to desorb the volatile component. The volatile component is injected into the mass spectrometer at an interface temperature of 320° C. to determine the area of the peak associated with the solvent. The quantification uses a calibration curve obtained from known amounts of the same solvent in advance. The weight of the solvent thus calculated is divided by the weight of the specimen after drying to determine the residual solvent content. It should be noted, however, that the measurement procedure discussed above is illustrative; the measurement conditions may be changed depending on the temperature at which the resin used decomposes or changes or the boiling point of the solvent.

An eluent 84 for dissolving the resin is then applied to the surface of the dry coating 81, as illustrated in FIG. 5B. The eluent 84 enters the dry coating 81 and swells the region under the surface where the eluent 84 is applied. The resin contained in the region under the surface where the eluent 84 is applied dissolves into the eluent 84, while little conductor 83 dissolves or travels into the eluent 84.

As the resin dissolves into the eluent 84, the conductor 83 is more concentrated in the region under the surface where the eluent 84 is applied than in the other region. Thus, a region 81B where the conductor 83 is localized is formed in the coating 81, as illustrated in FIG. 5C.

The eluent 84 for dissolving the resin is selected from a variety of solvents capable of dissolving the resin. As used herein, the phrase “capable of dissolving the resin” means that the solvent dissolves 10% by mass or more of the resin (solid content) at 25° C.

The eluent 84 may be the same as the solvent used for the coating solution. For example, if the coating solution is a polyimide precursor solution, polar solvents may be used, including N,N-dialkylamides (e.g., N,N-dimethylformamide, N,N-dimethylacetoamide, N,N-diethylformamide, N,N-diethylacetoamide, and N,N-dimethylmethoxyacetoamide), dimethyl sulfoxide, hexamethylphosphortriamide, N-methyl-2-pyrrolidone, pyridine, tetramethylenesulfone, and dimethyltetramethylenesulfone. Such solvents may be used alone or in combination.

The amount of eluent 84 applied is, for example, 0.001 to 1 g/cm², preferably 0.01 to 1 g/cm², more preferably 0.01 to 0.5 g/cm².

For example, the eluent 84 may be applied to the inner surface with a blade, or may be applied to a portion of the inner surface and be spread over the entire surface by centrifugation.

The eluent 84 is then removed from the surface of the coating 81 by drying to expose a resin film 82 on the cylindrical mold 91, as illustrated in FIG. 5D.

The eluent 84 contains the resin dissolved from the coating 81. As the eluent 84 dries, the resin contained in the eluent 84 precipitates, thus forming a resin region on the region where the conductor 83 is localized.

Because the eluent 84 contains no conductor 83 or a smaller amount of conductor 83 than the other region, a conductor-depleted region 82C containing no or little conductor 83 is formed on the region where the conductor 83 is localized. A conductor-localized region 82B where the conductor 83 is localized is formed under the conductor-depleted region 82C. A conductor-containing region 82A containing the conductor 83 at a lower concentration than the conductor-localized region 82B is formed under the conductor-localized region 82B. The conductor-depleted region 82C may contain a slight amount of conductor 83.

If the resin is a polyimide precursor solution, the dried resin film 82 is heated to 200° C. to 350° C. to facilitate imide conversion (baking step), thus forming a polyimide film.

The conductor-depleted region 82C is then removed from the surface of the resin film 82 by polishing to obtain a resin film including two regions with different conductor concentrations (conductor-localized region 82B and conductor-containing region 82A), as illustrated in FIG. 5E.

The resin film is released from the cylindrical mold 91 and is cut to the width corresponding to the width of the conductive elastic layer 113 to obtain a tubular member that forms the conductive resin layer 114.

The roller member, which includes, the hollow or solid cylindrical conductive support 112 and the conductive elastic layer 113 disposed on the outer surface of the conductive support 112, is inserted into the tubular member manufactured by the transfer process or concentration process discussed above to provide the conductive resin layer 114 on the outer surface of the conductive elastic layer 113. Thus, the conductive roller 111 according to this exemplary embodiment is manufactured.

### Image-Forming Apparatus and Process Cartridge

An image-forming apparatus according to this exemplary embodiment includes the conductive roller according to this exemplary embodiment.

Specifically, the image-forming apparatus according to this exemplary embodiment includes, for example, an image carrier, a charging unit that charges a surface of the image carrier, a latent-image forming unit that forms a latent image on the charged surface of the image carrier, a developing unit that develops the latent image formed on the surface of the image carrier with a toner to form a toner image, and a transfer unit that transfers the toner image from the surface of the image carrier to a recording medium. For example, the charging unit or the transfer unit includes the conductive roller according to this exemplary embodiment.

The charging unit includes, for example, a charging roller alone or in combination with a cleaning roller. The charging unit may include the conductive roller according to this exemplary embodiment as at least one of the above rollers.

The transfer unit employs, for example, a direct transfer system or an intermediate transfer system. The direct transfer system includes a transfer roller alone. The intermediate transfer system includes an intermediate transfer member having a surface to which a toner image is transferred from the surface of the image carrier, a first transfer roller that transfers the toner image from the surface of the image carrier to the surface of the intermediate transfer member, and a second transfer roller that transfers the toner image from the surface of the intermediate transfer member to the recording medium. The transfer unit may include the conductive roller according to this exemplary embodiment as at least one of the above rollers.

The image-forming apparatus according to this exemplary embodiment may be, for example, a monochrome image-forming apparatus including a developing device containing a monochrome toner, an image-forming apparatus that directly transfers a toner image from an image carrier to a recording medium, a color image-forming apparatus that sequentially transfers toner images from image carriers to an intermediate transfer member, or a tandem color image-forming apparatus in which image carriers provided with developing devices for different colors are arranged in tandem along an intermediate transfer member.

A process cartridge according to this exemplary embodiment is, for example, attachable to and detachable from the above image-forming apparatus. The process cartridge according to this exemplary embodiment includes at least the conductive roller according to this exemplary embodiment. Specifically, the process cartridge according to this exemplary embodiment includes at least one unit selected from the group consisting of an image carrier, a charging unit that charges a surface of the image carrier, a developing unit that develops a latent image formed on the surface of the image carrier with a toner to form a toner image, a transfer roller that transfers the toner image from the surface of the image carrier to a recording medium, and a cleaning unit that removes residual toner from the surface of the image carrier after the transfer. For example, the charging unit or the transfer unit includes the conductive roller according to this exemplary embodiment.

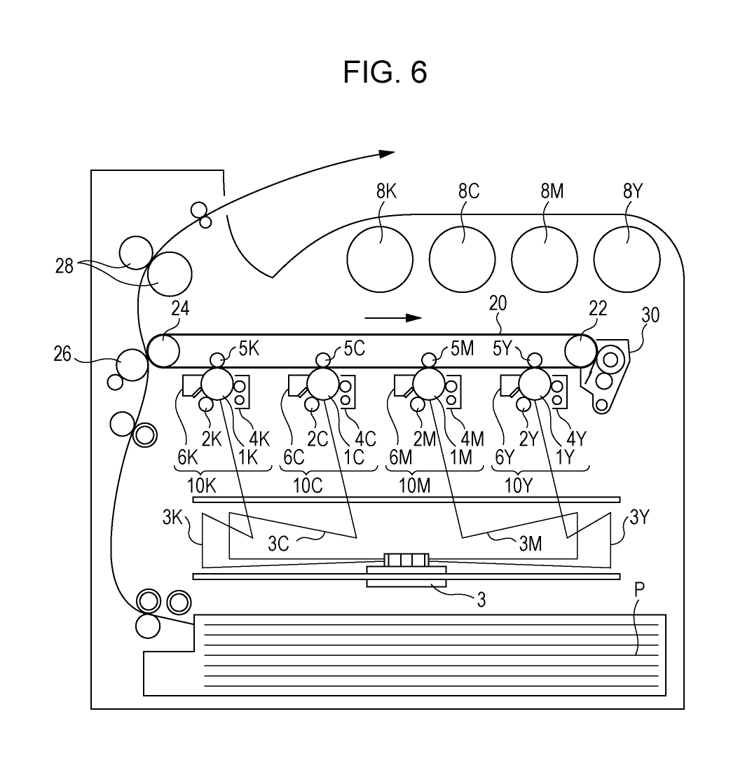

The image-forming apparatus according to this exemplary embodiment will now be described with reference to the drawings. FIG. 6 is a schematic view of the image-forming apparatus according to this exemplary embodiment.

The image-forming apparatus illustrated in FIG. 6 includes first to fourth electrophotographic image-forming units 10Y, 10M, 10C, and 10K that produce yellow (Y), magenta (M), cyan (C), and black (K) images, respectively, based on color separation image data. The image-forming units (hereinafter “units”) 10Y, 10M, 10C, and 10K are arranged in parallel at a particular spacing in the horizontal direction. The units 10Y, 10M, 10C, and 10K may also be process cartridges attachable to and detachable from the image-forming apparatus.

An intermediate transfer belt 20, provided as an intermediate transfer member, extends over the units 10Y, 10M, 10C, and 10K in FIG. 6. The intermediate transfer belt 20 is entrained about a drive roller 22 and a support roller 24 spaced apart from each other in the direction from the left to the right in FIG. 6 and disposed in contact with the inner surface of the intermediate transfer belt 20. The transfer unit of the image-forming apparatus is configured such that the intermediate transfer belt 20 travels in the direction from the first unit 10Y toward the fourth unit 10K.

A spring (not shown), for example, biases the support roller 24 in the direction away from the drive roller 22 to apply a particular tension to the intermediate transfer belt 20 entrained about the two rollers 22 and 24. An intermediate-transfer-member cleaning device 30 is disposed opposite the drive roller 22 on the image carrier side of the intermediate transfer belt 20.

The units 10Y, 10M, 10C, and 10K include developing devices (developing units) 4Y, 4M, 4C, and 4K, respectively, to which yellow, magenta, cyan, and black toners can be supplied from toner cartridges 8Y, 8M, 8C, and 8K, respectively.

The first to fourth units 10Y, 10M, 10C, and 10K have the same structure. The description herein will concentrate on the first unit 10Y, which is located upstream in the travel direction of the intermediate transfer belt 20 and which forms a yellow image. The elements of the second to fourth units 4M, 4C, and 4K corresponding to those of the first unit 10Y are designated by like numerals followed by “M” (magenta), “C” (cyan), and “K” (black), respectively, rather than “Y” (yellow), and are not further described herein.

The first unit 10Y includes a photoreceptor 1Y that functions as an image carrier. The photoreceptor 1Y is surrounded by, in sequence, a charging roller 2Y that charges the surface of the photoreceptor 1Y to a particular potential, an exposure device 3 that exposes the charged surface to a laser beam 3Y based on a color separation image signal to form an electrostatic image, a developing device (developing unit) 4Y that supplies a charged toner to the electrostatic image to develop the electrostatic image, a first transfer roller (first transfer unit) 5Y that transfers the developed image to the intermediate transfer belt 20, and a photoreceptor-cleaning device (cleaning unit) 6Y that removes residual toner from the surface of the photoreceptor 1Y with a cleaning blade after the first transfer.

The first transfer roller 5Y is disposed opposite the photoreceptor 1Y inside the intermediate transfer belt 20. The first transfer rollers 5Y, 5M, 5C, and 5K have connected thereto bias power supplies (not shown) that apply a first transfer bias thereto. A controller (not shown) controls the bias power supplies to change the transfer bias applied to the first transfer rollers 5Y, 5M, 5C, and 5K.

The image-forming operation of the first unit 10Y will now be described. Before the operation, the charging roller 2Y charges the surface of the photoreceptor 1Y to a potential of about −600 to about −800 V.

The photoreceptor 1Y includes a conductive substrate (having a volume resistivity at 20° C. of 1×10⁶ Ωcm or less) and a photosensitive layer disposed on the substrate. The photosensitive layer, which normally has high resistivity (comparable to the resistivity of common resins), has the property of changing its resistivity in a region irradiated with the laser beam 3Y. The exposure device 3 directs the laser beam 3Y onto the charged surface of the photoreceptor 1Y based on yellow image data received from the controller (not shown). The laser beam 3Y irradiates the photosensitive layer of the photoreceptor 1Y to form an electrostatic image with a yellow print pattern on the surface of the photoreceptor 1Y.

The electrostatic image is an image formed by the charge on the surface of the photoreceptor 1Y. Specifically, the electrostatic image is a negative latent image formed on the surface of the photoreceptor 1Y after the charge dissipates from the region irradiated with the laser beam 3Y, where the resistivity drops, while remaining in the region not irradiated with the laser beam 3Y.

As the photoreceptor 1Y rotates, the electrostatic image formed on the photoreceptor 1Y is brought to a particular development position where the electrostatic image is visualized (developed) by the developing device 4Y.

The developing device 4Y contains, for example, a yellow toner. The yellow toner is charged to the same polarity (negative) as the photoreceptor 1Y by friction as it is stirred inside the developing device 4Y. The charged yellow toner is carried by a developer roller (developer carrier). As the surface of the photoreceptor 1Y passes through the developing device 4Y, the yellow toner is electrostatically attracted to the latent image, which is neutral, on the surface of the photoreceptor 1Y. The yellow toner thus develops the latent image. The photoreceptor 1Y carrying the yellow toner image rotates at a particular speed to transport the toner image developed on the photoreceptor 1Y to a particular first transfer position.

When the yellow toner image on the photoreceptor 1Y is transported to the first transfer position, a particular first transfer bias is applied to the first transfer roller 5Y. The toner image is transferred from the photoreceptor 1Y to the intermediate transfer belt 20 by electrostatic force acting from the photoreceptor 1Y toward the first transfer roller 5Y. The transfer bias applied has the opposite polarity (positive) to the toner (negative). The transfer bias is controlled to, for example, about +10 μA in the first unit 10Y by the controller (not shown).

The cleaning device 6Y removes and collects residual toner from the photoreceptor 1Y.

The controller similarly controls the first transfer biases applied to the first transfer rollers 5M, 5C, and 5K of the second to fourth units 10M, 10C, and 10K.

Thus, the intermediate transfer belt 20 having the yellow toner image transferred thereto by the first unit 10Y is sequentially transported through the second to fourth units 10M, 10C, and 10K, which superimpose toner images of the respective colors on top of each other.

The intermediate transfer belt 20, having the toner images of the four colors superimposed thereon through the first to fourth units 10Y, 10M, 10C, and 10K, reaches a second transfer section. The second transfer section includes the intermediate transfer belt 20, the support roller 24 disposed in contact with the inner surface of the intermediate transfer belt 20, and a second transfer roller (second transfer unit) 26 disposed on the image carrier side of the intermediate transfer belt 20. A recording medium P is fed into a nip between the second transfer roller 26 and the intermediate transfer belt 20 at a particular timing by a feed mechanism. A particular second transfer bias is applied to the support roller 24. The transfer bias applied has the same polarity (negative) as the toner (negative). The toner image is transferred from the intermediate transfer belt 20 to the recording medium P by electrostatic force acting from the intermediate transfer belt 20 toward the recording medium P. The second transfer bias is determined depending on the resistance detected by a resistance detector (not shown) that detects the resistance of the second transfer section, and the voltage is controlled accordingly.

The recording medium P is transported to a fixing device (fixing unit) 28. The fixing device 28 fixes the toner images to the recording medium P by fusing together the superimposed toner images with heat. The recording medium P having the color image fixed thereto is transported to an eject section. Thus, the color-image forming operation is complete.

While the illustrated image-forming apparatus is configured to transfer the toner images to the recording medium P via the intermediate transfer belt 20, it may be configured in any other manner. For example, the image-forming apparatus may be configured to directly transfer the toner images from the photoreceptors 1Y, 1M, 1C, and 1K to the recording medium P.

### EXAMPLES

The present invention is further illustrated by the following non-limiting examples, where parts are by mass unless otherwise indicated.

### Fabrication of Coated Roller Member

### Fabrication of Coated Roller 1

A mixture of 60 parts of epichlorohydrin rubber (EPICHLOMER CG-102 from Daiso Co., Ltd.), which has high ionic conductivity with its ethylene oxide group, and 30 parts of acrylonitrile-butadiene rubber (NIPOL DN-219 from Zeon Corporation) is prepared. To the mixture, 1 part of sulfur (from Tsurumi Chemical, Co., Ltd., 200 mesh), 1.5 parts of a vulcanization accelerator (NOCCELER M from Ouchi Shinko Chemical Industrial Co., Ltd.), and 6 parts of benzenesulfonylhydrazide, as a foaming agent, are added, and the mixture is kneaded in an open roll. The mixture is then applied around a stainless steel support roller (conductive support) having a diameter of 12 mm. The stainless steel support roller is heated to 160° C. as a heat source to vulcanize and foam the mixture wound therearound for two hours, thus forming a conductive elastic layer on the conductive support. The conductive elastic layer is polished to an outer diameter of 28 mm (thickness of conductive elastic layer: 8 mm) to obtain a roller 1 coated with a conductive elastic layer.

The Asker C hardness of the conductive elastic layer of the coated roller 1 is measured by placing a measurement needle of an Asker C durometer (from Kobunshi Keiki Co., Ltd.) on the surface of the conductive elastic layer. The Asker C hardness measured under a load of 1,000 g is 40°.

### Fabrication of Conductive Resin Layer Member

### Fabrication of Covering Tube 1

To an N-methyl-2-pyrrolidone (NMP) solution of a polyamic acid of 3,3′,4,4′-biphenyltetracarboxylic dianhydride and 4,4′-diaminodiphenylether (solid content after imide conversion: 18% by mass), carbon black (Special Black 4 from Degussa AG) is added in an amount of 80 parts per 100 parts (solid content) of the polyamic acid. The mixture is subjected to dispersion and mixing to obtain a dispersion using a jet mill (Geanus PY from Geanus, cross-sectional area of smallest portion of collision part: 0.032 mm²) by passing the mixture through a dispersion unit five times under a pressure of 200 MPa.

To the dispersion, the NMP solution of the polyamic acid (solid content after imide conversion: 18% by mass) is added in an amount of 27 parts per 100 parts (solid content) of the polyamic acid. The dispersion is stirred using a planetary mixer (Aicoh Mixer from Aicohsha Manufacturing Co., Ltd.) to obtain a carbon-black-dispersed polyimide precursor solution.

An aluminum cylinder having an outer diameter of 28 mm, a length of 500 mm, and a wall thickness of 6 mm is provided. The surface of the aluminum cylinder is roughened to a surface roughness Ra of 0.35 μm by blasting with spherical glass particles. A mixture of 100 g of a silicone release agent (KS700 from Shin-Etsu Chemical Co., Ltd.) and 1 g of a conductor (tin oxide, Passtran 6010 from Mitsui Mining & Smelting Co., Ltd.) is applied to the surface of the cylinder immediately after they are mixed and stirred together and is baked at 300° C. for one hour. Thus, an aluminum cylinder coated with a release agent layer containing a conductor is fabricated.

While the aluminum cylinder is rotated at 50 rpm, with the axis thereof being horizontal, the carbon-black-dispersed polyimide precursor solution is applied to a thickness of 0.625 mm on the outer surface of the cylinder using a dispenser.

While the cylinder coated with the carbon-black-dispersed polyimide precursor solution is rotated at 6 rpm, with the axis thereof being horizontal, the coating is dried with heat at 60° C. for 25 minutes and at 120° C. for 40 minutes to form a carbon-black-dispersed polyimide precursor dry film. The dry film is then heated at 200° C. for 30 minutes, at 260° C. for 30 minutes, at 300° C. for 30 minutes, and at 320° C. for 20 minutes to form a carbon-black-dispersed polyimide film. The carbon-black-dispersed polyimide film is removed from the aluminum cylinder and is cut to the width corresponding to the width of the conductive elastic layer of the coated roller 1.

Thus, a tubular carbon-black-dispersed polyimide film is fabricated as a covering tube 1.

### Fabrication of Covering Tube 2

A tubular carbon-black-dispersed polyimide film is fabricated as in the fabrication of the covering tube 1 except that a mixture of 100 g of a silicone release agent (KS700 from Shin-Etsu Chemical Co., Ltd.) and 3 g of a conductor (tin oxide, Passtran 6010 from Mitsui Mining & Smelting Co., Ltd.) is applied to the surface of the aluminum cylinder immediately after they are mixed and stirred together. The tubular carbon-black-dispersed polyimide film is referred to as a covering tube 2.

### Fabrication of Covering Tube 3

A tubular carbon-black-dispersed polyimide film is fabricated as in the fabrication of the covering tube 1 except that a mixture of 100 g of a silicone release agent (KS700 from Shin-Etsu Chemical Co., Ltd.) and 0.5 g of a conductor (tin oxide, Passtran 6010 from Mitsui Mining & Smelting Co., Ltd.) is applied to the surface of the aluminum cylinder immediately after they are mixed and stirred together. The tubular carbon-black-dispersed polyimide film is referred to as a covering tube 3.

### Fabrication of Covering Tube 4

A tubular carbon-black-dispersed polyimide film is fabricated as in the fabrication of the covering tube 1 except that a mixture of 100 g of a silicone release agent (KS700 from Shin-Etsu Chemical Co., Ltd.) and 4 g of a conductor (tin oxide, Passtran 6010 from Mitsui Mining & Smelting Co., Ltd.) is applied to the surface of the aluminum cylinder immediately after they are mixed and stirred together. The tubular carbon-black-dispersed polyimide film is referred to as a covering tube 4.

### Fabrication of Covering Tube 5

A tubular carbon-black-dispersed polyimide film is fabricated as in the fabrication of the covering tube 1 except that a silicone release agent (KS700 from Shin-Etsu Chemical Co., Ltd.) is applied to the surface of the aluminum cylinder immediately after they are mixed and stirred together. The tubular carbon-black-dispersed polyimide film is referred to as a covering tube 5.

### Example 1

### Fabrication of Conductive Roller 1

The coated roller 1 is inserted into the covering tube 1 while blowing air therein. Thus, a conductive roller 1 including the conductive elastic layer and the covering tube 1 disposed thereon as a conductive resin layer is fabricated.

### Measurement of Surface Resistivity of First and Second Regions of Conductive Resin Layer

The conductive resin layer of the conductive roller 1 is cut open into a sheet. The sheet is cut in the center thereof to form a 4×4 cm measurement sample.

The surface resistivity of the measurement sample is measured on the surface corresponding to the outermost surface of the conductive resin layer and on the surface corresponding to the surface adjoining the conductive elastic layer by the surface resistivity measurement procedure described above. The surface resistivity of the surface corresponding to the outermost surface of the conductive resin layer is the surface resistivity of the first region. The surface resistivity of the surface corresponding to the surface adjoining the conductive elastic layer is the surface resistivity of the second region. The common logarithms (log Ω/sq) of the measurements are shown in Table 1 below.

### Example 2

### Fabrication of Conductive Roller 2

A conductive roller 2 is fabricated as in the fabrication of the conductive roller 1 except that the covering tube 1 is replaced by the covering tube 2. The measurements of the surface resistivity of the conductive resin layer are shown in Table 1.

### Example 3

### Fabrication of Conductive Roller 3

A conductive roller 3 is fabricated as in the fabrication of the conductive roller 1 except that the covering tube 1 is replaced by the covering tube 3. The measurements of the surface resistivity of the conductive resin layer are shown in Table 1.

### Example 4

### Fabrication of Conductive Roller 4

A conductive roller 4 is fabricated as in the fabrication of the conductive roller 1 except that the covering tube 1 is replaced by the covering tube 4. The measurements of the surface resistivity of the conductive resin layer are shown in Table 1.

### Comparative Example 1

The as-fabricated coated roller 1 is used as a conductive roller.

### Comparative Example 2

### Fabrication of Conductive Roller 5

A conductive roller 5 is fabricated as in the fabrication of the conductive roller 1 except that the covering tube 1 is replaced by the covering tube 5. The measurements of the surface resistivity of the conductive resin layer are shown in Table 1.

### Comparative Example 3

### Fabrication of Conductive Roller 6

To an urethane resin dilution containing 100 parts of an N,N-dimethylformamide solution of a polyether urethane resin (KK124 from Dainichiseika Color & Chemicals Mfg. Co., Ltd., solid content: 30% by mass), 250 parts of N,N-dimethylformamide, and 50 parts of methyl ethyl ketone, 12 parts of carbon black (#3030B from Mitsubishi Chemical Corporation) is added, and the mixture is dispersed using a bead mill to obtain a coating solution. The coating solution is applied to the outer surface of the coated roller 1 by spraying. The coated roller 1 is then inserted into the covering tube 5. The coating is dried at 160° C. for 90 minutes to form an adhesive layer. Thus, a conductive roller 6 including the conductive elastic layer and the covering tube 5 provided as a conductive resin layer with an adhesive layer therebetween is fabricated.

The conductive roller 6 has variations in hardness due to entry of the cured coating into foam cells in the conductive elastic layer.

### Evaluations

The conductive rollers of the Examples and the Comparative Examples are mounted as a first transfer roller on an image-forming apparatus based on DocuCentre Color 2220 from Fuji Xerox Co., Ltd. (process speed: 500 mm/sec, first transfer current: 4045 μA). The image-forming apparatus is used to continuously form a general pattern of characters and patches on 50,000 sheets of C² A4-size paper from Fuji Xerox Co., Ltd. at 10° C. and 15% RH for the following evaluations. The results are shown in Table 1, where “Before” refers to the results before the formation of the image on 50,000 sheets of paper, and “After” refers to the results after the formation of the image on 50,000 sheets of paper.

### Volume Resistance Measurement

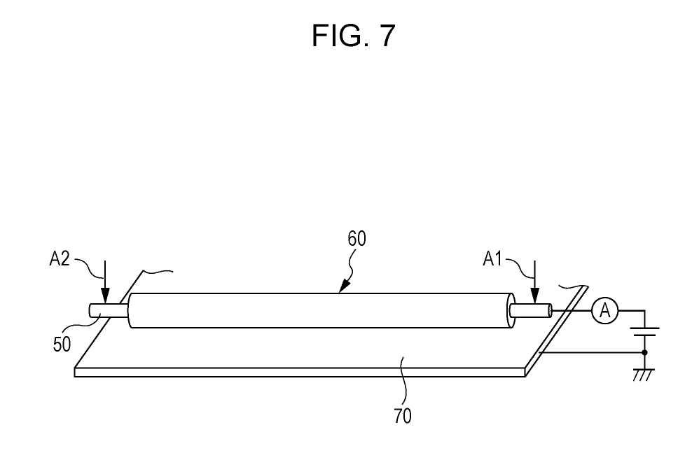

The volume resistance (R) (Ω) of the conductive rollers is measured before and after the formation of the image on 50,000 sheets of paper. The measurement procedure will now be described with reference to FIG. 7.

As illustrated in FIG. 7, a conductive roller 60 is placed on a metal plate 70. A voltage of 1,000 V is applied across a core 50 and the metal plate 70 at 22° C. and 55% RH while applying a load of 500 g to the positions indicated by the arrows A1 and A2 at both ends of the core 50. The current I (A) is read after 10 seconds, and the volume resistance (R) is calculated by the equation R=V/I. This measurement and calculation is carried out at four positions by rotating the conductive roller 60 by 90° in the circumferential direction, and the average volume resistance (R) is calculated as the volume resistance (R) of the conductive roller 60. Table 1 shows the common logarithms of the volume resistance (log Ω).

### Image Quality

Halftone images (with image densities of 20%, 30%, and 40%) are formed on entire sheets of paper before and after the formation of the image on 50,000 sheets of paper. The images are visually inspected to evaluate their image quality according to the following criteria:

A: The halftone images have no density variations.

B: The halftone images have slight, acceptable density variations.

C: The halftone images have some density variations.

D: The halftone images have white spots.

TABLE 1

| | | | Surface resistivity of conductive | | | | | | | |
|---|---|---|---|---|---|---|---|---|---|---|
| | | | resin layer (logΩ/sq) | | | | | | | |
| | | | | | Difference | | | | | |
| | | | | | (first region − | Volume resistance of | | | Image | |
| | | | First | Second | second | conductive roller (logΩ) | | | quality | |
| | | | region | region | region) | Before | After | Difference | Before | After |
| Ex. 1 | Conductive | Covering tube 1 | 11.10 | 9.91 | 1.19 | 7.10 | 7.52 | 0.42 | A | A |
| | roller 1 | | | | | | | | | |
| Ex. 2 | Conductive | Covering tube 2 | 11.10 | 8.41 | 2.69 | 6.90 | 7.35 | 0.45 | A | A |
| | roller 2 | | | | | | | | | |
| Ex. 3 | Conductive | Covering tube 3 | 11.10 | 10.68 | 0.42 | 7.12 | 7.76 | 0.64 | A | B |
| | roller 3 | | | | | | | | | |
| Ex. 4 | Conductive | Covering tube 4 | 11.10 | 7.93 | 3.17 | 6.62 | 7.06 | 0.44 | B | B |
| | roller 4 | | | | | | | | | |
| Com. | Coated roller 1 | | — | | | 7.00 | 8.12 | 1.12 | A | D |
| Ex. 1 | | | | | | | | | | |
| Com. | Conductive | Covering tube 5 | 11.20 | 11.41 | −0.21 | 7.20 | 7.93 | 0.73 | A | C |
| Ex. 2 | roller 5 | | | | | | | | | |

| | | | | | | | | |
|---|---|---|---|---|---|---|---|---|
| Com. | Conductive | Covering tube | — | 7.14 | 8.11 | 0.97 | C | D |
| Ex. 3 | roller 6 | 5 with | | | | | | |
| | | adhesive layer | | | | | | |

The results shown in Table 1 demonstrate that the conductive rollers of the Examples maintain their low volume resistances after repeated use more effectively than those of the Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A conductive roller comprising:
a conductive support;
a conductive elastic layer disposed on the conductive support; and
a conductive resin layer disposed on the conductive elastic layer and containing a resin and a conductor, the conductive resin layer including a first region forming an outermost surface thereof and a second region between the first region and the conductive elastic layer, the second region adjoining the conductive elastic layer and having a lower surface resistivity than the first region.

2. The conductive roller according to claim 1, wherein the first and second regions have a difference in common logarithm of surface resistivity (log Ω/sq) of about 1 to about 3.

3. The conductive roller according to claim 1, wherein the second region contains a larger amount of conductor than the first region.

4. The conductive roller according to claim 2, wherein the second region contains a larger amount of conductor than the first region.

5. An image-forming apparatus comprising the conductive roller according to claim 1.

6. A process cartridge attachable to and detachable from an image-forming apparatus, comprising the conductive roller according to claim 1.
